(19) United States
(12) Patent Application Publication
(10) Pub. No.: US 2005/0269204 A1
(43) Pub. Date: Dec. 8, 2005

(54) Reverse emulsion with biological material

(75) Inventor: Zbigniew T. Bryning, Campbell, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 10/861,223

(22) Filed: Jun. 4, 2004

(51) Int. Cl. G01N 27/27; G01N 27/453

(52) U.S. Cl. 204/452; 204/602

(57) ABSTRACT

The present teachings relate to methods and devices for handling micelles in a reverse emulsion with biological material.

### FIELD

The present teachings relate to reverse emulsions as a medium for capture, separation, and concentration of biological material such as, for example, biomolecules and bioparticles upon application of an electric current.

### INTRODUCTION

Typical separation and detection techniques use aqueous solutions, e.g. water, as a buffer. In typical contactless detection methods, a sample of, e.g., cells is provided in water and is subjected to an electric field. A profile of the impedance, or absorbance, of the field by the sample is then measured, and cell types are distinguished based on different profiles. Water can not be the ideal solvent in such methods because water tends to shield the sample from the electric field. That is, in aqueous solutions, the electrophoretic forces can be too weak by the time they reach the sample. Emulsions, for example reverse emulsions, can improve separation and detection techniques, for example contactless separation and detection techniques, where aqueous solutions can be used as a solvent.

Emulsions typically include at least one surfactant and at least two immiscible liquids, for example water and a non-aqueous solvent. They can be further characterized as containing a continuous phase (water) and a disperse phase (droplets of non-aqueous solvent stabilized by a surfactant). More particularly, the disperse phase can be constituted by micelles, in which the non-polar end of the surfactant molecules is dissolved in the non-aqueous solvent droplets, and the polar end of the surfactant molecules is dissolved in the continuous aqueous phase. Such emulsions are commonly referred to as oil-in-water (o/w) emulsions.

The present teachings relate to water-in-oil (w/o) emulsions, also referred to as reverse emulsions. Reverse emulsions also typically include at least one surfactant and at least two immiscible liquids, but are characterized as having a disperse aqueous phase and a continuous non-aqueous phase. The disperse aqueous phase is constituted by “reverse micelles,” in which the polar end of the surfactant molecules is dissolved in the water droplets and the non-polar end of the surfactant molecules is dissolved in the continuous non-aqueous phase.

Reverse emulsions can encapsulate small molecules, such as dyes. These dye-encapsulated reverse micelles can be used in reverse emulsion electrophoretic displays. In such displays, a reverse emulsion containing a dye is injected into a space between two glass plates with spaced electrodes. Upon application of an appropriate electric field, the reverse micelles can be contract into microscopic droplets or uniformly distributed over the volume. Each of these behaviors is associated with an image on the display.

The encapsulation of molecules and particles by reverse micelles can provide separation media. For example: biphasic extraction of amino acids between bulk water solutions and reverse microemulsions, as well as their solubilization in the reverse micellar phase; reverse micelles of AOT (bis(2-ethylhexyl) sodium succinate) for the selective transport of tryptophan and p-iodophenylalanine; liquid-liquid extraction of proteins using reverse micelles; hydrophilic bulky proteins with molecular weights larger than 60 kDa, such as catalase, β-galactoside, bovine serum albumin, and hemoglobin, can be solubilized into a microwater pool of AOT reverse micelles by an injection method, because proteins and enzymes solubilized into reverse micelles maintain their activities and native structures, and can be back-extracted.

It is desirable to provide reverse micelles to encapsulate biomolecules (e.g., proteins, DNA, RNA), and bioparticles (e.g., organelles and cells), and apply electric current to the reverse micelles results in the exhibition of certain behaviors. These behaviors can include at least one of concentration and separation of the micelles in the reverse emulsion, each of which is at least partially a function of the differences in charges and polarizability of the micelles.

### SUMMARY

In various embodiments, there is provided a method for handling micelles in a reverse emulsion, including applying a sufficient voltage across the reverse emulsion to impart movement to at least one micelle, wherein the at least one micelle contains at least one entity chosen from biomolecules and particles.

In various embodiments, there is provided an apparatus for handling micelles in a reverse emulsion, including at least one channel and a power source that is configured to apply a voltage across the channel for moving at least one of the micelles in the reverse emulsion, wherein the at least one micelle contains at least one entity chosen from biomolecules and particles.

In various embodiments, there is provided a method of separating components in a composition, wherein the composition includes at least one reverse emulsion, and the reverse emulsion includes reverse micelles encapsulating at least one entity chosen from biomolecules and bioparticles, said method including applying a sufficient voltage across the reverse emulsion to separate a first reverse micelle from a second reverse micelle.

It is to be understood that both the foregoing general description and the following description of various embodiments are exemplary and explanatory only and are not restrictive.

### BRIEF DESCRIPTION OF THE DRAWINGS

The accompanying drawings, which are incorporated in and constitute a part of this specification, illustrate various embodiments.

FIGS. 1A-1G illustrate hela cells in various solutions In the present teachings;

FIG. 2 is a schematic model of the AOT/isooctane/water reverse micellar system In the present teachings;

FIGS. 3A-3C illustrate a schematic of some reverse emulsion micelles In the present teachings;

FIG. 4 illustrates an exemplary apparatus for the electrophoretic separation of a reverse emulsion In the present teachings;

FIGS. 5A-5D illustrate the behavior of a reverse emulsion in an electric field In the present teachings;

FIGS. 6A-6C illustrate the behavior of a reverse emulsion in an electric field In the present teachings;

FIG. 7A-7D illustrate the separation of protein-encapsulated reverse micelles In the present teachings; and

FIG. 8 illustrates the behavior of a reverse emulsion of whole blood upon application of an electric current In the present teachings.

### DESCRIPTION OF VARIOUS EMBODIMENTS

Reverse emulsions can be associated with distinct properties including formation, stability, and association patterns. For example, the surfactant aggregation process in non-aqueous solvents can be different from that of water-based systems. The orientation of the surfactant relative to the bulk solvent is opposite to that in water, giving rise to the term “reverse emulsion.” In aqueous solutions, the force primarily driving micelle formation is the hydrophobic effect, e.g., minimization of the unfavorable interactions between water and the hydrophobic part of the surfactant molecule. In non-aqueous emulsion formation, electrostatic interactions between the ionic head groups of the surfactant and the nonpolar continuous phase play an important role in emulsion formation.

Reverse micelles are thermodynamically stable water droplets, within a water-immiscible solvent, stabilized by a monolayer of surfactant molecules. They can be formed by contacting an aqueous phase with an immiscible non-aqueous phase containing the surfactant(s). The inner core of a reverse micelle can contain an aqueous microphase, which is capable of solubilizing various substances, including molecules and particles.

The term “biological material” as used herein can refer to components in biological fluids (e.g. blood, lymph, urine, sweat, etc.), to reactants, and/or to reaction products, any of which can include at least one of particles, bioparticles, biomolecules, and other charged species.

The term “particle” as used herein refers to a relatively small subdivision of matter ranging in diameter from a few angstroms to a few millimeters. A particle can have various shapes and dimensions. The term “bioparticle” as used herein refers to particles formed by, or useful in, any biological process. Suitable non-limiting examples of bioparticles can include cells, formed blood elements, cell organelles (for example chromosomes), cell aggregates, tissue, bacteria, protozoans, viruses, embryos, and other small organisms. The bioparticles can be, for example, a mixture of cell types, such as fetal nucleated red blood cells in a mixture of maternal blood, or red blood cells infested with malarial parasites. The term “formed blood elements” as used herein refers to blood components that can include, by way of example, erythrocytes, platelets, neutrophils, small lymphocytes, large lymphocytes, monocytes, eosinophils, and basophils. Organelles include, for example, mitochondria.

The term “biomolecule” as used herein refers to any molecule associated with a life function. Suitable non-limiting examples of biomolecules can include proteins, peptides, nucleotides, DNA, RNA, and other nucleic acids.

The term “handling” as used herein refers to unit operations that can include at least one of separation, characterization, differentiation and manipulation of biomolecule and/or particle-encapsulated reverse micelles. The present teachings provide methods for handling reverse micelles in which biomolecules and/or particles are encapsulated.

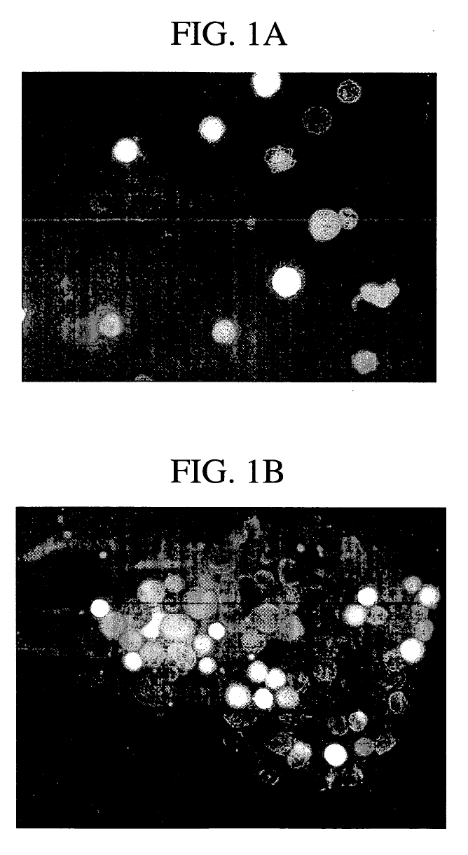

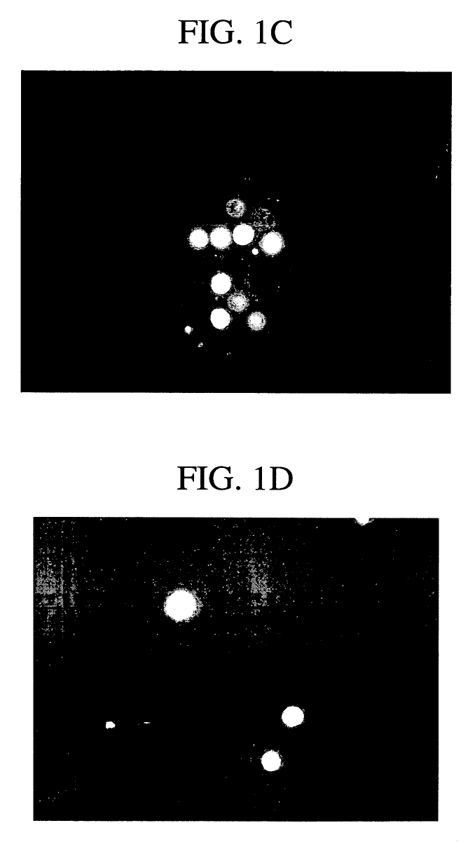

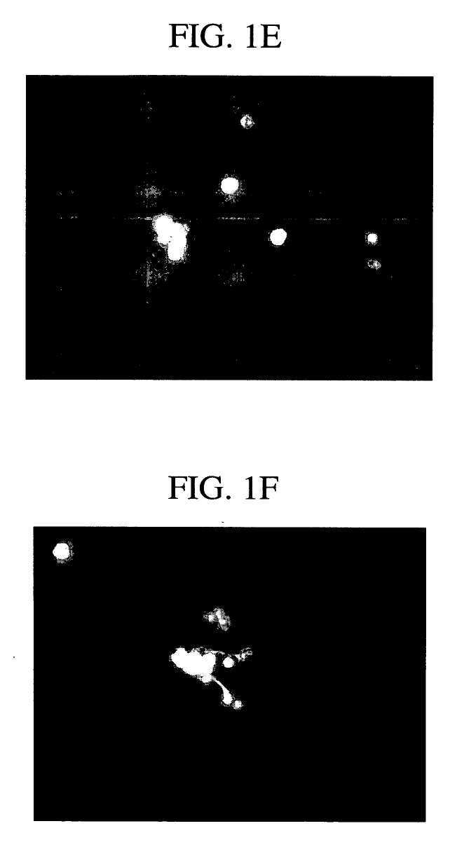

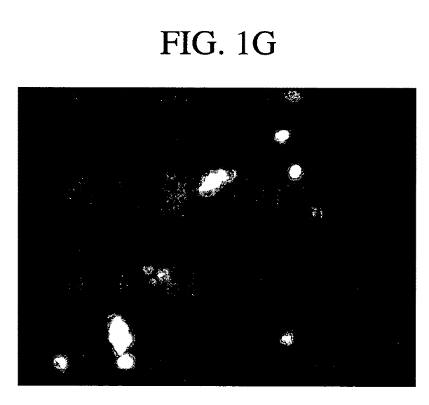

FIGS. 1A-1G illustrate the behavior of hela cells in various systems. FIG. 1A is an image of hela cells, stained with calcein AM, in a salted buffer. FIGS. 1B and 1C illustrate hela cells in droplets of water within dodecylbenzene. FIGS. 1D and 1E show individual hela cells within reverse micelles (one cell per micelle) in a dodecylbenzene/bis(2-ethylhexyl) sodium sulfosuccinate system. FIGS. 1F and 1G show reverse micelles in a trimethylpentane/bis(2-ethylhexyl) sodium sulfosuccinate system. As can be seen in FIG. 1F, the cell within the single water droplet is beginning to rupture. In FIG. 1G, the cell membrane ruptures, and the contents of the cell are borne away in separate reverse micelles.

In various embodiments, the ability of a reverse micelle to enclose biomolecules or particles can depend on the properties of the biomolecules and particles themselves, the surfactant(s) used to make the reverse emulsion, and the water:surfactant ratio. The size, shape, electric charge, and polarizability (with strong low frequency components) of the reverse micelles can depend on the properties of enclosed biomolecules or particles. Without being bound by any specific mechanism or theory, it is believed that it is these parameters that make it possible to concentrate and/or separate reverse micelles upon the application of an electric current (e.g., direct current, alternating current, or traveling waves). These same parameters can be used for contactless electric detection and classification of reverse micelles.

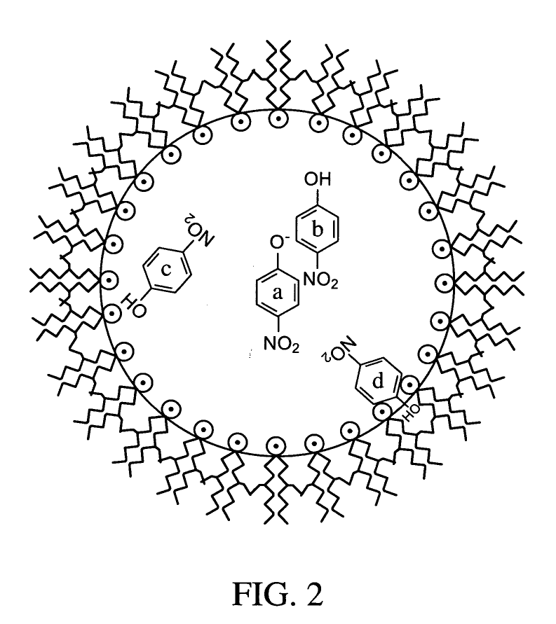

FIG. 2 provides an example of a reverse micelle model, using AOT-reverse micelles. The 4-nitrophenol molecules are shown in the water pool, which has a gradient micro-polarity environment that exerts a continuous influence on the ionization of 4-nitrophenol in the water pool of the system. The pool core, designated by the center region of the large circle, includes free water molecules. Traveling from the pool area in the center region to the interface at the inner circumference of the large circle there is an increasing amount of bound-water with affinity to the interface and decreasing mobility. This model explains the molecular basis of the displacement of 4-nitrophenol from the interface region to the water pool. Chang et al., Proc. Natl. Sci. Counc. ROC(B), 24:3, pp. 89-100 (2000).

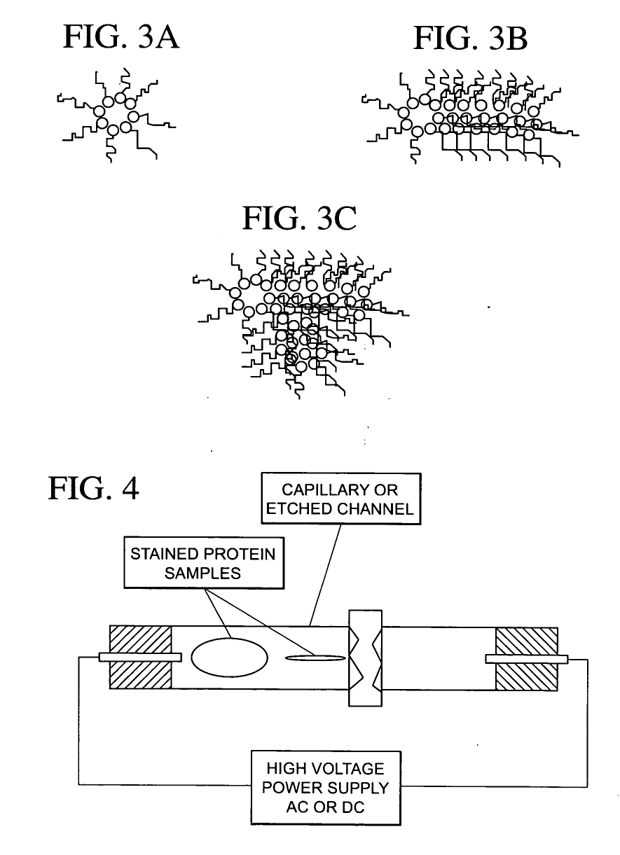

In various embodiments, reverse micelles can take a variety of forms. Largely dependent on the molecular structure of the amphiphile, a number of three-dimensional supramolecular structures can be formed, ranging from spherical, rod or worm-like micelles, to bilayer or multilayer structures, and other arrangements. FIG. 3 is exemplary and illustrates three possible structures that occur in reverse emulsions: (a) spherical micelle, (b) tubular aggregate, and (c) three-dimensional network. Typically, conical-shaped surfactants maximize their intermolecular interactions by adopting a spherical structure.

In various embodiments, reverse microemulsions In the present teachings include a reverse emulsion that is characterized by droplets that are on the order of several nanometers in diameter, as opposed to the micron-sized micelles of standard emulsions. Microemulsions are thermodynamically stable, and thus can be less susceptible to settling or other degradation. Reverse microemulsions can be made with the use of two or more surfactants, for example a surfactant and a co-surfactant, which are capable of creating a zero or negative surface tension at the interface between the two phases.

In various embodiments, the diameter, or volume, of the reverse micelles can be controlled by varying the relative amounts of water and surfactant. For example, increasing the water content while holding the surfactant content constant can increase the volume of the reverse micelles. Conversely, holding the water content constant while increasing the surfactant concentration can cause the volume of the reverse micelles to decrease. Also, if the water and surfactant concentrations are increased in a constant ratio, the volume of the reverse micelles can remain unchanged but the number of vesicles can increase. Martinek et al., Biochim. Biophys. Acta, 981:161-172 (1989).

In various embodiments, there are a number of different ways in which biomolecules and particles, for example bioparticles, can be embedded in reverse micelles. For example, in the “phase transfer method,” the surfactant is dissolved in the organic solvent and, separately, the protein is dissolved in an aqueous solution. The two solutions are then mixed to form a reverse micellar system. Another method is the “injection method,” in which a small volume of a solution, for example an aqueous protein solution, is injected into a surfactant/organic solvent composition. A transparent micellar solution can then be created by gently shaking the vessel. This method has been employed for the solubilization of beta-galactoside into AOT/isooctane reverse micelles. Another method, which can be useful when a substance, such as a protein, is insoluble in water, is the “direct solubilization method.” Direct solubilization can be accomplished by combining, e.g., a protein powder with a water-organic solvent solution, and mixing the resulting composition to dissolve the protein.

The structures of biomolecules and bioparticles can be sensitive to the surfactants and/or solvents used in a reverse emulsion system. For example, the biomolecules can denaturize in certain solutions. Those of ordinary skill in the art will appreciate that the selection of any one of the foregoing methods can allow for embedding biomolecules and/or bioparticles in reverse micelles while at least minimizing the occurrence of denaturation.

In various embodiments, solvents can include those that are capable of forming a reverse emulsion in the presence of at least one immiscible liquid, for example water, and at least one surfactant. By way of non-limiting examples, such solvents can include xylene, hexanol, dimethylformamide, trimethylpentane (e.g., 2,2,4-trimethylpentane), dodecylbenzene, and tetralin. For electrophoretic separation of reverse emulsions, a suitable solvent can be based in part on its conductivity. For example, In various embodiments, the conductivity of a pure solvent useful in accordance with the present invention can range up to and include 10⁻¹⁹ Ω⁻¹ cm⁻¹. In various embodiments, the solvent can be a mixture.

In various embodiments, the reverse emulsions useful in accordance with the present teachings include at least one surfactant. Suitable surfactants include those that are capable of reducing the surface tension between immiscible liquids. For example, suitable surfactants include those chosen from bis(2 ethylhexyl) sodium sulfosuccinate (commonly referred to as “AOT”), n-hexadecyltrimethyl ammonium bromide, cetyltrimethylammonium bromide, dimethyldioctadecyl ammonium bromide, trioctylmethylammonium chloride (also referred to as “TOMAC”), and dioctyldimethylammonium chloride (also referred to as “DODMAC”).

In various embodiments, a combination of surfactants can be used in accordance with the present invention. By way of non-limiting examples, suitable surfactant combinations for the purposes of the present invention include bis(2-ethylhexyl) sodium sulfosuccinate and n-hexadecyltrimethyl ammonium bromide, and bis(2-ethylhexyl) sodium sulfosuccinate and dimethyldioctadecyl ammonium bromide. In various embodiments, relative amounts of surfactant in each combination can range from, for example, 1:10 to 10:1. In various embodiments, the surfactants in each combination can be present in a 1:1 ratio.

In various embodiments, the biomolecules and particles can be of any size, provided they are capable of being encapsulated by reverse micelles. For example, particles ranging in size from 10 nm to 1 mm. In various embodiments, bioparticles, such as cells, can be separated without modification such as ligands, stains, antibodies or other means. Cells can remain undamaged, unaltered and viable during and following separation.

In various embodiments, the present teachings can provide an electrophoretic separation of components in a composition. Electrophoresis is known in the art of handling biological material as a process for concentrating and/or separating charged species. It can be employed as a means for separating large molecules (such as DNA fragments or proteins) from a mixture of similar molecules. This is accomplished by passing an electric current through a medium containing the mixture. Each kind of molecule travels through the medium at a different rate, depending on its electrical charge and size. Separation of the molecules can be based on these differences and the sieving effect of the medium.

In various embodiments, reverse micelles encapsulating biomolecules and/or bioparticles can be separated via electrophoresis. In various embodiments, the reverse micelles can be charged species, and the magnitude of the charge can depend at least in part on the properties of the encapsulated biomolecules and/or bioparticles.

In various embodiments, the present teachings can provide a method for the detection and separation of particles, including bioparticles such as, for example, formed blood elements and organelles thereof. There are instances, known to those of ordinary skill in the art, in which it is desirable to separate components of whole blood. In various embodiments, a reverse emulsion of whole blood can be created. Components of the whole blood can be captured in the reverse micelles, and the reverse micelles can be manipulated upon application of a voltage across the reverse emulsion.

In various embodiments, FIG. 4 illustrates portions of an apparatus suitable for concentration, separation, reaction, or otherwise handling of a biological sample. The device can include a capillary or etched channel containing stained protein samples, electrodes, and a high voltage power supply. The electrodes can be constructed of a platinum wires or any other appropriate material suitable for applying a voltage across the etched channel or capillary. In various embodiments, a glass capillary is used having an internal diameter of 1 mm, an outside diameter of 1.5 mm, and a length of 30 mm. This material and dimensions are illustrative only, and can be altered by one of ordinary skill in the art of microfluidics to any material and dimensions.

In various embodiments, the voltage applied across the etched channel or capillary as illustrated in FIG. 4 can range from, for example, 1 volt to 15 kilovolts. The frequency can range from, for example, 0 kHz to 1 kHz. The voltage and frequency are illustrative only, and can be altered by one skilled in the art of, e.g., electrophoretic separation.

In various embodiments, detection methods include, for example absorbance, spectroscopy (fluorescence or Raman), reflectance, colorimetry, conductivity detection, acoustic/electroacoustic detection, and any other detection method known in the art of analysis of biological materials. For example, any detection method employing the application of an electric field and/or based on electrophoretic properties can be used, such as fluorescent dye excitation and detection of emitted light. Detection can be provided with a detector which can be any component relevant to the detection methods described herein, such as a charge coupled device or photodiode for fluorescent light detection.

In various embodiments, a biological material can be subjected to a contactless detector employing a high frequency field. The contactless detector measures the profile of the impedence, or absorbance, of the field. In the case of cells as a sample, different cells have different profiles, and the cells can be classified based on those different profiles. These profiles can be more sharply pronounced when a reverse emulsion, rather than water, is used as the handling medium.

### EXAMPLES

The following examples are illustrative and are non-limiting to the present teachings.

### Example 1

### Movement of Reverse Micelles in an Electric Field

Example 1 illustrates the preparation of two reverse emulsions, and the behavior of each emulsion upon application of an electric current. Two reverse emulsions were prepared, and the behavior of each was observed in an electric field. The micelles of the first reverse emulsion (E1) encapsulated FM13, which is a 17-mer peptide, positively charged at pH 7.5, made up in water at 40 μM, and labeled with FAM (Hongye Sun). Emulsion E1 included 5 μl FM3, 10 μl 0.5 M bis(2-ethylhexyl)sodium sulfosuccinate in trimethyl pentane, and 40 μl of trimethyl pentane. A reverse microemulsion was thus formed.

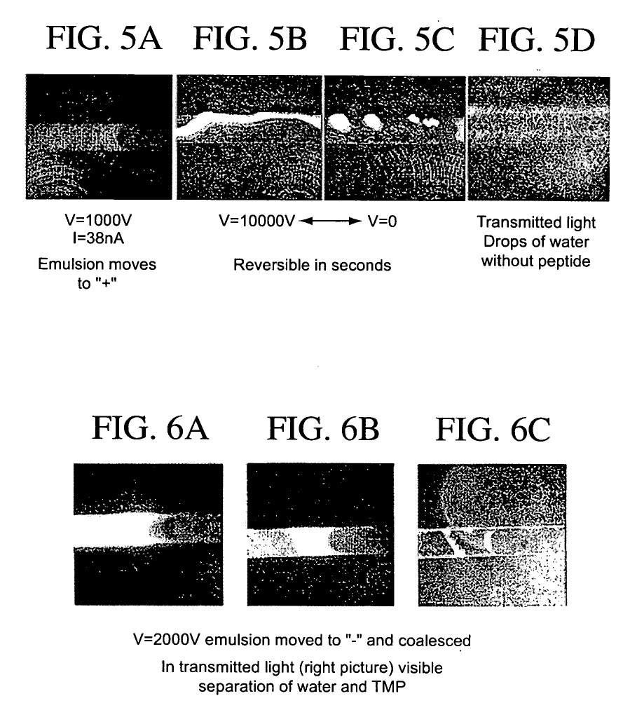

An electric current was applied across reverse emulsion E1 as follows: A microchannel was provided by an etching process. The microchannel had dimensions of 5 cm in length, 100 μm in width, and 50 μm in depth. The channel was filled with a reverse emulsion, and on each end of the reverse emulsion was a plug of ionic liquid. The ionic liquid plugs acted as electrodes. A platinum wire was fed to each of the ionic liquid plugs. First, a current of 38 nA at 1000V was applied to the reverse emulsion. As shown in FIG. 5A, the micelles migrated to the cathode. Second, the voltage was cycled from 0V to 10 kV and back. As shown in FIGS. 5B and 5C, the formation of the reverse emulsion was reversible in seconds. FIG. 5D shows transmitted light through reverse micelles without the peptide.

The micelles of the second reverse emulsion, (E2), encapsulated AcaM, which is a protein with a molecular weight of 16.7 kDa, negatively charged at pH 7.5, and made up in water at 24 μM concentration. AcaM was also labeled with FAM. Emulsion E2 included 5 μl AcaM, 10 μl 0.5 M sodium bis(2-ethylhexyl)sodium sulfosuccinate in 2,2,4-trimethylpentane, and 40 μl of 2,2,4-trimethylpentane. In this instance, the reverse emulsion separated.

2000V were applied across the reverse emulsion E2. As shown in FIGS. 6A and 6B, the reverse micelles migrated to the anode and coalesced. FIG. 6C shows, using transmitted light, the visible separation of water and trimethylpentane.

### Example 2

### Separation of Proteins in a Reverse Emulsion

Example 2 illustrates the separation of various proteins encapsulated within reverse micelles. The proteins were components of Polypeptide Standards (Bio-Rad, Hercules, Calif.), including five uniquely colored proteins having molecular weights ranging from 3.5 to 32 kDa. In this instance, the five proteins were carbonic anhydrase, soybean trypsin inhibitor, lysozyme, aprotinin, and insulin chain B. A 500 μl sample of the standard had a pH of 7.0 and contained 1.6 mg total protein in 33% (v/v) glycerol, 0.5% SDS, 10 mM Tris, 10 mM DTT, 2 mM EDTA, and 0.01% NaN₃.

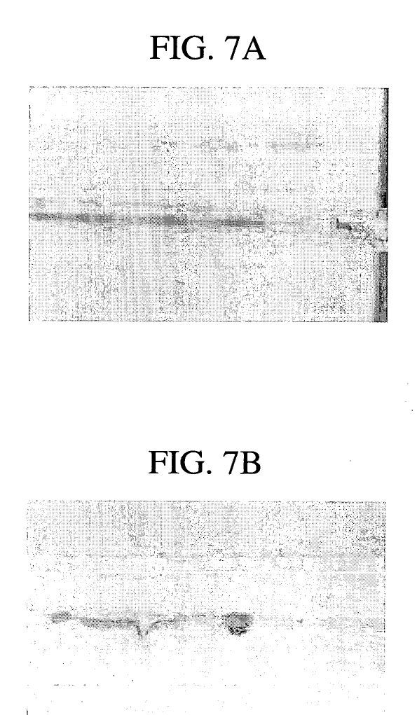

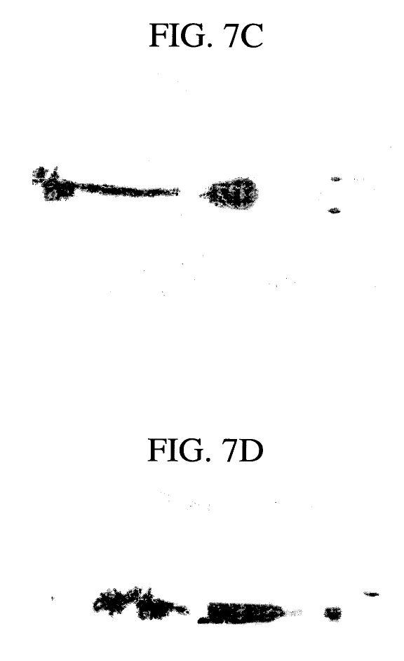

The polypeptide standard was incorporated into a reverse emulsion including 20 μl of the polypeptide standard, 20 μl, of 0.5M bis(2-ethylhexyl) sulfosuccinate in trimethylpentane, and 80 μl, trimethylpentane. Portions of the reverse emulsion were placed in a capillary. A direct current voltage was applied up to 4000V, with currents ranging up to 20 μA. FIGS. 7A-7D show the separation upon application of the voltage. Separation was observed by color differentiation of the individual proteins in a “red-blue” color scheme.

FIG. 7A shows the reverse emulsion five minutes after voltage was applied. The reverse micelles encapsulating red protein started to form a string at the center of the figure. The reverse micelles encapsulating the blue protein formed a tip on the right side of the string. Voltage was applied for another length of time, and a small amount of the reverse micelles encapsulating the blue protein migrated to the electrode. The micelles became compressed, and appeared to contain only blue protein.

As shown in FIG. 7B, the reverse micelles encapsulating the blue protein moved in the opposite direction when the voltage was reversed. The red, by contrast, folded upon itself. As shown in FIG. 7C, the voltage was reversed again to continue the separation process. Here, the string of reverse micelles encapsulating the red protein migrated to the left, the cloud of reverse micelles encapsulating the purple protein moved to the center, and the cloud of reverse micelles encapsulating the blue protein formed on the right. FIG. 7D shows the position of the reverse micelles after the voltage was reversed several times. The reverse micelles encapsulating the red, blue, and purple micelles separated into distinct clouds. With regard to the reverse micelles encapsulating the red protein (left), the dipole moment was so strong that the reverse micelles collapsed and formed a gel.

### Example 3

### Separation of Blood Components in a Reverse Emulsion

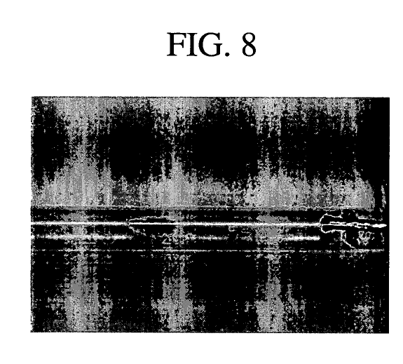

Example 3 illustrates the separation of blood components from whole blood in a reverse micellar system. In this example, a reverse emulsion of whole blood was prepared, including 5 μl of blood in 150 μl 0.5M sodium bis(2-ethylhexyl)sulfosuccinate in trimethyl pentane, and an additional 250 μl trimethylpentane. The reverse emulsion was provided in a capillary, and a voltage was applied across the capillary. As shown in FIG. 8, a cloud of reverse micelles encapsulating blood cells moved to the left side of the capillary. Another cloud of reverse micelles formed needle-like projections on the electrode on the right side of the capillary. When voltage application ceased, the needle-like projections diffused. This example demonstrates that application of an electric field to a reverse emulsion of blood permits the separation of subsets of cells from each other.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. Thus, for example, reference to “a charged species” includes two or more different charged species. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to various embodiments described herein without departing from the spirit or scope of the present teachings. Thus, it is intended that the various embodiments described herein cover other modifications and variations within the scope of the appended claims and their equivalents.

1. A method for handling micelles in a reverse emulsion, the method comprising:
applying voltage across the reverse emulsion to impart movement to at least one micelle, wherein the at least one micelle encapsulates at least one material chosen from biomolecules and particles.

2. The method In claim 1, wherein the particles are chosen from bioparticles.

3. The method of claim 1, further comprising applying a sufficient voltage across the reverse emulsion to concentrate micelles in said reverse emulsion.

4. The method of claim 3, further comprising detecting the concentrated micelles.

5. The method of claim 4, wherein the concentrated micelles are detected by at least one of absorbance, spectroscopy, reflectance, colorimetry, conductivity detection, and acoustic/electroacoustic detection.

6. The method of claim 1, further comprising applying a sufficient voltage across the reverse emulsion to separate micelles in said reverse emulsion.

7. The method of claim 6, further comprising detecting the separated micelles.

8. The method of claim 7, wherein the separated micelles are detected by at least one of absorbance, spectroscopy, reflectance, colorimetry, conductivity detection, and acoustic/electroacoustic detection.

9. The method of claim 1, further comprising extracting at least one entity chosen from biomolecules and particles from the reverse emulsion.

10. The method of claim 1, wherein the biomolecules are chosen from proteins, peptides, nucleotides, DNA, and RNA.

11. The method of claim 2, wherein the bioparticles are chosen from cells, formed blood elements, cell organelles, cell aggregates, tissue, bacteria, protozoans, viruses, and embryos.

12. The method of claim 11, wherein the bioparticles are chosen from formed blood elements.

13. The method of claim 1, wherein applying the voltage comprises applying a varying voltage based on one of a direct current, an alternating current, or traveling waves to produce a varying electric field.

14. The method of claim 1, wherein the reverse emulsion is a reverse microemulsion.

15. The method of claim 1, wherein the reverse emulsion comprises water droplets dispersed in at least one solvent.

16. The method of claim 1, wherein the reverse emulsion comprises at least one surfactant and at least one solvent.

17. The method of claim 16, wherein the at least one surfactant is chosen from bis(2-ethylhexyl) sodium sulfosuccinate, n-hexadecyltrimethyl ammonium bromide, and dimethyldioctadecyl ammonium bromide.

18. The method of claim 16, wherein the at least one solvent is chosen from organic solvents.

19. The method of claim 18, wherein the organic solvent is chosen from trimethylpentane, xylene, dodecylbenzene, and tetralin.

20. The method of claim 19, wherein the trimethyl pentane is 2, 2, 4-trimethylpentane.

21. An apparatus for handling micelles in a reverse emulsion, comprising:
at least one channel;
a reverse emulsion in the at least one channel; and
a power source that is configured to apply a voltage across the channel for moving at least one micelle in the reverse emulsion, wherein the at least one micelle encapsulates a material chosen from biomolecules and particles.

22. The apparatus of claim 21, wherein the at least one channel is chosen from microchannels and capillaries.

23. The apparatus of claim 21, wherein the particles are chosen from bioparticles.

24. The apparatus of claim 21, wherein the biomolecules are chosen from proteins, peptides, DNA, RNA, and nucleotides.

25. The apparatus of claim 23, wherein the bioparticles are chosen from cells, formed blood elements, cell organelles, cell aggregates, tissue, bacteria, protozoans, viruses, and embryos.

26. The apparatus of claim 21, wherein the power source is configured to apply voltages that range from 100 to 15000 volts.

27. The apparatus of claim 21, wherein the power source is configured to produce an electric field that varies based on at least one of an alternating current, or direct current being supplied to the power source.

28. A system for handling biological materials, the system comprising:
a reverse emulsion with micelles encapsulating at least one material chosen from biomolecules and bioparticles;
a channel containing the emulsion;
electrodes positioned proximate to the channel;
a power source coupled to the electrodes; and
a detector positioned proximate to the channel and reverse emulsion.

29. The system of claim 28, wherein the detector comprises a charge coupled device or photodiode.

30. The system of claim 28, wherein the detector comprises a contactless detector.
